(19) United States
(12) Patent Application Publication
(10) Pub. No.: US 2025/0190846 A1
(43) Pub. Date: Jun. 12, 2025

(54) PROVIDING GUIDANCE ON THE USE OF MACHINE LEARNING TOOLS

(71) Applicant: International Business Machines Corporation, Armonk, NY (US)

(72) Inventors: Jun Wang, XIAN (CN); Si Er Han, XIAN (CN); Bo Song, XIAN (CN); Dong Hai Yu, Xian (CN); Yao Dong Liu, Xian (CN); Jiang Bo Kang, XIAN (CN)

(21) Appl. No.: 18/530,313

(22) Filed: Dec. 6, 2023

(51) Int. Cl. G06N 20/00

(52) U.S. Cl. CPC G06N 20/00

(57) ABSTRACT

A computer-implemented method for providing guidance on the use of machine learning tools is provided. Aspects include receiving, from a user, an input data set and a type of problem to solve based on the input data set and identifying a set of machine learning pipelines from a database comprising a plurality of machine learning pipelines. Aspects also include recommending, to the user, a first machine learning pipeline of the set of machine learning pipelines from the set of machine learning to the user, wherein each of the plurality of machine learning pipelines includes a pipeline score and wherein the first machine learning pipeline has a highest pipeline score of the set of machine learning pipelines and providing, to the user, a rule set associated with the first machine learning pipeline, wherein the rule set includes one or more suggested settings associated with the first machine learning pipeline.

### BACKGROUND

The present invention generally relates to social media platforms, and more specifically, to providing guidance on the use of machine learning tools.

The use of machine learning tools within organizations has drastically increased in recent years. In addition, the number of available machine learning tools, and the configuration options for these machine learning tools, has also increased. As a result, organizations have attempted to identify and communicate working experiences, or best practices, among individuals and teams to optimize the use of these machine learning tools.

In many organizations, the current methods of sharing working experiences, or best practices, among individuals and teams are relatively traditional. For example, these methods often include offline and online technical training sessions, writing a blog post to share the experience on a knowledge-sharing location of the organization, such as an internal webpage or internal bulletin board system, or the like. In practice, when individuals want to obtain and apply these organizational best practices to a new project, the efficiency of reusing those best practices and leveraging them for improving production is quite low.

One of the reasons for the low efficiency is that obtaining the best practices depends on other individuals recording these best practices in a knowledge-sharing location. In addition, even if the knowledge-sharing asset contains the needed information, an individual may often not be able to locate the desired information due to poor organization of the knowledge-sharing location.

### SUMMARY

Embodiments of the present invention are directed to a computer-implemented method for providing guidance on the use of machine learning tools. The computer-implemented method includes receiving, from a user, an input data set and a type of problem to solve based on the input data set and identifying, based at least in part on the input data set and the problem, a set of machine learning pipelines from a database comprising a plurality of machine learning pipelines. The computer-implemented method also includes recommending, to the user, a first machine learning pipeline of the set of machine learning pipelines from the set of machine learning to the user, wherein each of the plurality of machine learning pipelines includes a pipeline score and wherein the first machine learning pipeline has a highest pipeline score of the set of machine learning pipelines and providing, to the user, a rule set associated with the first machine learning pipeline, wherein the rule set includes one or more suggested settings associated with the first machine learning pipeline.

Embodiments of the present invention are directed to a computer-implemented method for creating a database of machine learning pipelines for guidance on use of machine learning tools. The computer-implemented method includes obtaining a plurality of machine learning experiments performed by users, wherein each of the plurality of the machine learning experiment includes an input data set and a type of problem to solve based on the input data set and creating a machine learning pipeline for each of plurality of the machine learning experiments, the machine learning pipeline including a sequence of stages including one or more of data ingestion, data validation, feature extraction, machine learning model/version selection, training data selection/preparation, model training, model evaluation, and model validation performed during the machine learning experiments. The computer-implemented method also includes obtaining a plurality of metrics for each of the machine learning pipelines, obtaining a set of scoring rules for scoring the machine learning pipeline, wherein the set of scoring rules are based on the plurality of metrics, characteristics of the input data set, the type of the problem, and calculate a pipeline score for each of the machine learning pipelines by applying the set of scoring rules to the plurality of metrics, characteristics of the input data set, the type of the problem.

Embodiments also include computing systems and computer program products for providing guidance on the use of machine learning tools and for creating a database of machine learning pipelines for guidance on use of machine learning tools.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a schematic diagram of a computing environment in accordance with one or more embodiments of the present invention;

FIG. 2 is a block diagram illustrating a machine learning experiment system for providing guidance on the use of machine learning tools in accordance with one or more embodiments of the present invention;

FIG. 3 is a flow diagram illustrating a method for providing guidance on the use of machine learning tools in accordance with one or more embodiments of the present invention;

FIG. 4 is a schematic diagram illustrating a method for creating a machine learning pipeline based on a machine learning experiment in accordance with one or more embodiments of the present invention;

FIG. 5 is a table illustrating types of machine learning pipelines and characteristics of the input data set for each machine learning pipeline in accordance with one or more embodiments of the present invention;

FIG. 6 is a table illustrating a table of machine learning pipelines, which each include machine learning modules, settings, and performance metrics in accordance with one or more embodiments of the present invention;

FIG. 7 is a flow diagram illustrating a computer-implemented method for providing guidance on the use of machine learning tools in accordance with one or more embodiments of the present invention; and

FIG. 8 is a flow diagram illustrating a computer-implemented method for creating a database of machine learning pipelines for guidance on the use of machine learning tools in accordance with one or more embodiments of the present invention.

The diagrams depicted herein are illustrative. There can be many variations to the diagram or the operations described therein without departing from the spirit of the invention. For instance, the actions can be performed in a differing order, or actions can be added, deleted, or modified. Also, the term “coupled” and variations thereof describes having a communications path between two elements and does not imply a direct connection between the elements with no intervening elements/connections between them. All of these variations are considered a part of the specification.

### DETAILED DESCRIPTION

As discussed above, organizations have developed systems for identifying and communicating working experience, or best practices, among individuals and teams for the use of these machine learning tools. However, currently available systems are inefficient and do not sufficiently enable the capturing and sharing of best practices, particularly in the area of designing and executing machine learning experiments.

Embodiments of the present invention are directed to methods and systems for providing guidance on the use of machine learning tools. In exemplary embodiments, a machine learning experiment system is provided and individuals within an organization utilize the machine learning experiment system to design and execute machine learning experiments. The machine learning experiment system is configured to capture machine learning experiments that are performed and to create a machine learning pipeline for each executed machine learning experiment. In exemplary embodiments, each machine learning experiment is associated with an input data set and with a type of problem to be solved by analyzing the input data set. The machine learning experiment system is also configured to collect metrics, such as performance metrics, regarding the machine learning experiment. The machine learning experiment system saves these machine learning pipelines and their associated metrics in a machine learning pipeline database, which is used to generate suggested machine learning pipelines for future machine learning experiments.

In exemplary embodiments, the machine learning experiment system is configured to receive an input data set and a type of problem to be solved from a user. Based on the input data set and the type of problem to be solved, the machine learning experiment system is configured to identify a machine learning pipeline from the machine learning pipeline database and to recommend the identified machine learning pipeline to the user. In exemplary embodiments, the machine learning experiment system is also configured to provide a rule set associated with the identified machine learning pipeline, where the rule set includes one or more suggested settings associated with the identified machine learning pipeline.

In one embodiment, a computer-implemented method for providing guidance on the use of machine learning tools is provided. The computer-implemented method includes receiving, from a user, an input data set and a type of problem to solve based on the input data set and identifying, based at least in part on the input data set and the problem, a set of machine learning pipelines from a database comprising a plurality of machine learning pipelines. The computer-implemented method also includes recommending, to the user, a first machine learning pipeline of the set of machine learning pipelines from the set of machine learning to the user, wherein each of the plurality of machine learning pipelines includes a pipeline score and wherein the first machine learning pipeline has a highest pipeline score of the set of machine learning pipelines and providing, to the user, a rule set associated with the first machine learning pipeline, wherein the rule set includes one or more suggested settings associated with the first machine learning pipeline. One technical benefit of implementing the method for providing guidance on the use of machine learning tools includes a reduction in the energy consumed by computing systems executing machine learning tools by performing non-optimal machine learning experiments, which will be repeated to obtain better results. In addition, the efficiency of the computing systems executing machine learning tools is improved by reducing the number of machine learning experiments that will be performed by the computing systems.

Additionally, or alternatively, in embodiments of the present invention each of the plurality of machine learning pipelines includes a sequence of stages that include one or more of data ingestion, data validation, feature extraction, machine learning model/version selection, training data selection/preparation, model training, model evaluation, and model validation.

Additionally, or alternatively, in embodiments of the present invention each of the plurality of machine learning pipelines includes a machine learning module associated with each of the sequence of stages.

Additionally, or alternatively, in embodiments of the present invention each of the plurality of machine learning pipelines are created based on an analysis of previously executed machine learning experiments and wherein each of the previously executed machine learning experiments is associated with a previous type of problem and a previous input data set.

Additionally, or alternatively, in embodiments of the present invention the set of machine learning pipelines is identified based on the previous type of problem being the same as the type of problem and a similarity between the previous input data set and the input data set exceeding a threshold value.

Additionally, or alternatively, in embodiments of the present invention each of the previously executed machine learning experiments includes a sequence of stages, a machine learning module associated with each of the sequence of stages, and one or more metrics associated with the previously executed machine learning experiments.

Additionally, or alternatively, in embodiments of the present invention the pipeline score of each of the plurality of machine learning pipelines is created by applying a set of scoring rules to the one or more metrics associated with the previously executed machine learning experiments.

Additionally, or alternatively, in embodiments of the present invention the one or more metrics associated with the previously executed machine learning experiments, include performance metrics for the machine learning modules associated with each of the sequence of stages.

In one embodiment, a computer-implemented method for creating a database of machine learning pipelines for guidance on use of machine learning tools is provided. The computer-implemented method includes obtaining a plurality of machine learning experiments performed by users, wherein each of the plurality of the machine learning experiment includes an input data set and a type of problem to solve based on the input data set and creating a machine learning pipeline for each of plurality of the machine learning experiments, the machine learning pipeline including a sequence of stages including one or more of data ingestion, data validation, feature extraction, machine learning model/version selection, training data selection/preparation, model training, model evaluation, and model validation performed during the machine learning experiments. The computer-implemented method also includes obtaining a plurality of metrics for each of the machine learning pipelines, obtaining a set of scoring rules for scoring the machine learning pipeline, wherein the set of scoring rules are based on the plurality of metrics, characteristics of the input data set, the type of the problem, and calculate a pipeline score for each of the machine learning pipelines by applying the set of scoring rules to the plurality of metrics, characteristics of the input data set, the type of the problem. One technical benefit of implementing the method for providing guidance on the use of machine learning tools includes a reduction in the energy consumed by computing systems executing machine learning tools by performing non-optimal machine learning experiments, which will be repeated to obtain better results. In addition, the efficiency of the computing systems executing machine learning tools is improved by reducing the number of machine learning experiments that will be performed by the computing systems.

Additionally, or alternatively, in embodiments of the present invention obtaining a plurality of metrics for each of the machine learning pipelines includes performing a statistical analysis on the input data set.

Additionally, or alternatively, in embodiments of the present invention obtaining a plurality of metrics for each of the machine learning pipelines includes grouping the plurality of machine learning experiments based on the type of problem and generating features and performance metrics for each group.

Additionally, or alternatively, in embodiments of the present invention obtaining a plurality of metrics for each of the machine learning pipelines further includes clustering each of the groups based on the generated features, identifying a cluster having a highest average performance metric.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as providing guidance on the use of machine learning tools (block 150). In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 135), and network module 115. Remote server 104 includes remote database 132. Public Cloud 105 includes gateway 130, Cloud orchestration module 131, host physical machine set 142, virtual machine set 143, and container set 144.

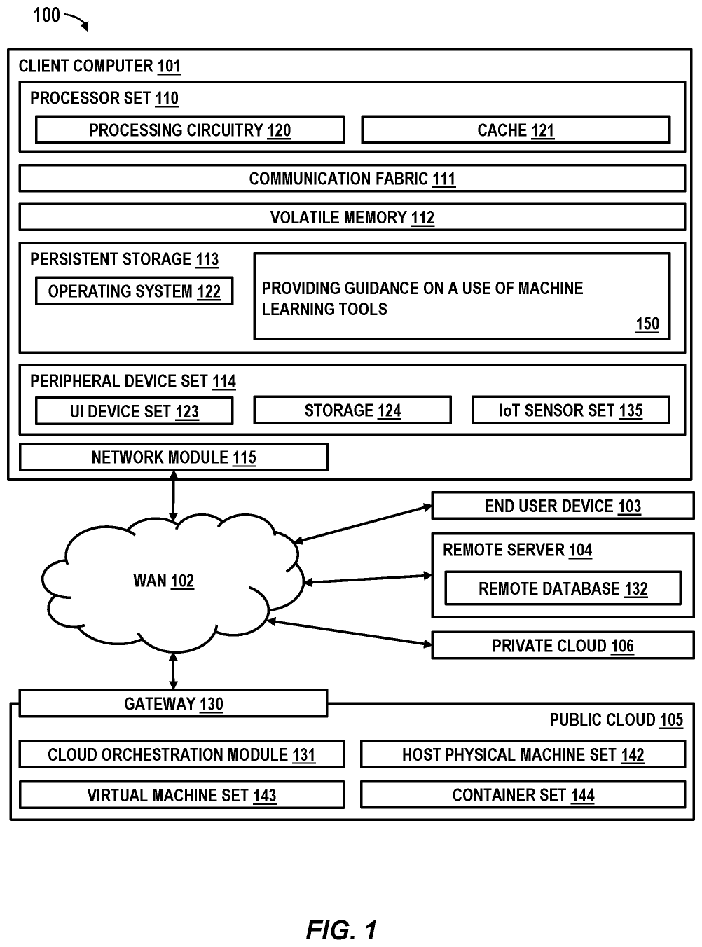

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

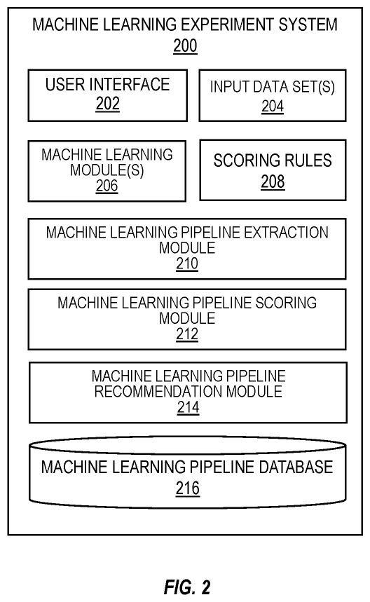

Referring now to FIG. 2, a block diagram illustrating a machine learning experiment system 200 for providing guidance on the use of machine learning tools in accordance with one or more embodiments of the present invention is shown. In exemplary embodiments, the machine learning experiment system 200 is embodied in a computing environment 100, such as the one shown in FIG. 1.

As illustrated, the machine learning experiment system 200 includes a user interface 202 that is configured to receive input from a user. In exemplary embodiments, the user interface 202 is configured to allow a user to design a machine learning experiment, input a type of problem to be solved via the machine learning experiment, and/or to identify an input data set 204 for the machine learning experiment. In embodiments where a user designs a machine learning experiment, the machine learning experiment system 200 includes a plurality of machine learning modules 206 that can be utilized in the machine learning experiment. In exemplary embodiments, machine learning experiments can be designed using a graphical user interface (GUI) tool or using a text editor, of the user interface 202.

In exemplary embodiments, the machine learning experiment system 200 also includes a machine learning pipeline extraction module 210 that is configured to analyze a machine learning experiment executed by a user, create a machine learning pipeline that corresponds to the machine learning experiment, and to store the machine learning pipeline into a machine learning pipeline database 216. In exemplary embodiments, a machine learning pipeline includes a sequence of stages that include one or more of data ingestion, data validation, feature extraction, machine learning model/version selection, training data selection/preparation, model training, model evaluation, and model validation. Each of these stages may be associated with one or more of the plurality of machine learning modules 206, which perform that stage of the machine learning pipeline.

In exemplary embodiments, the machine learning pipeline database 216 is configured to store all relevant data regarding machine learning experiments previously performed on the machine learning experiment system 200. The data stored in the machine learning pipeline database 216 for each previously performed machine learning experiment includes the machine learning pipeline, including an identification of each of the machine learning modules 206 that make up the machine learning pipeline, the type of problem solved by the machine learning experiment, the input data set of the machine learning experiment, settings of the machine learning modules 206 that make up the machine learning pipeline, performance metrics of the machine learning pipeline, and the like.

In exemplary embodiments, the machine learning pipeline database 216 is further configured to store a pipeline score for each machine learning pipeline. The pipeline score for each machine learning pipeline is created by a machine learning pipeline scoring module 212 of the machine learning experiment system 200. The machine learning scoring module 212 is configured to analyze each machine learning pipeline and to calculate a pipeline score for each pipeline based on a set of scoring rules 208. In an exemplary embodiment, the set of scoring rules 208 includes a plurality of rules that are set by an administrator of the machine learning experiment system 200 and reflect the preferences of the performance characteristics of the machine learning experiments of the organization operating the machine learning experiment system 200. In one embodiment, the pipeline score for a machine learning pipeline is calculated by summing up the score of the machine learning pipeline for each rule in the set of scoring rules 208.

In exemplary embodiments, the machine learning experiment system 200 also includes a machine learning pipeline recommendation module 214. The machine learning pipeline recommendation module 214 is configured to receive an input data set 204 and a type of problem to be solved by the machine learning experiment system 200 based on the input data set from a user. The machine learning pipeline recommendation module 214 is also configured to responsively recommend a machine learning pipeline to the user based on the input data set 204 and the type of problem to be solved.

In exemplary embodiments, the machine learning pipeline recommendation module 214 performs a statistical analysis on the input data set 204 and identifies a set of machine learning pipelines from the machine learning database 216 that have the same type of problem and an associated data set that has at least a threshold similarity to the input data set 204. In exemplary embodiments, the machine learning pipeline recommendation module 214 selects a machine learning pipeline from the set of machine learning pipelines based on the pipeline scores. For example, the machine learning pipeline recommendation module 214 selects the machine learning pipeline from the set of machine learning pipelines that has the highest pipeline score and recommends that machine learning pipeline to the user.

In exemplary embodiments, the machine learning pipeline recommendation module 214 is further configured to provide the user with a rule set associated with the recommended machine learning pipeline. The rule set includes one or more suggested settings associated with the recommended machine learning pipeline. For example, the rule set can contain configuration settings associated with the machine learning module 206 that make up the recommended machine learning pipeline.

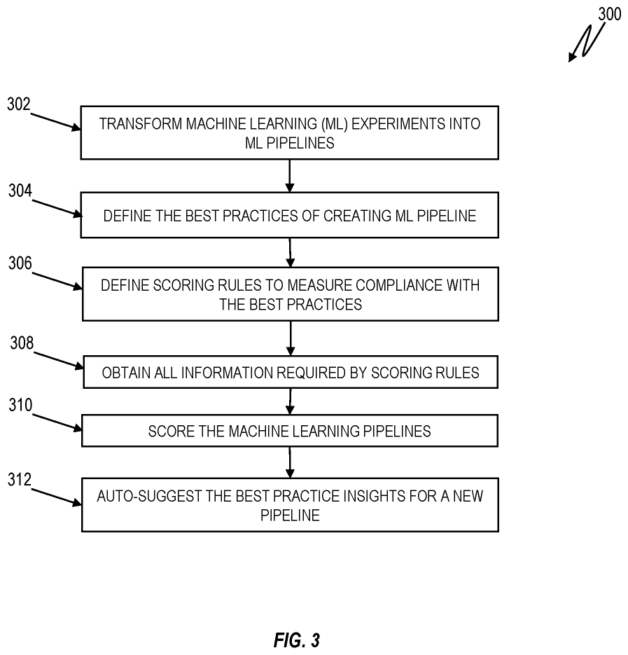

Referring now to FIG. 3, a flow diagram illustrating a method 300 for providing guidance on the use of machine learning tools in accordance with one or more embodiments of the present invention is shown. In exemplary embodiments, the method 300 is performed by a machine learning experiment system 200 such as the one shown in FIG. 2. At block 302, the method 300 begins by transforming machine learning experiments into machine learning pipelines. In exemplary embodiments, transforming the machine learning experiments into machine learning pipelines includes identifying a sequence of stages that include one or more of data ingestion, data validation, feature extraction, machine learning model/version selection, training data selection/preparation, model training, model evaluation, and model validation and a machine learning modules, associated with each stage of the machine learning pipeline.

Next, as shown at block 304, the method 300 includes defining the best practices of creating a machine learning pipeline. In one embodiment, defining the best practices of creating a machine learning pipeline includes collecting common best practices from publicly available sources in the machine learning field. For example, by searching the related content on the public internet and parsing the obtained content by text mining. In exemplary embodiments, the collection and analysis of such publicly available data can provide general best practices information such as data processing is required if the data quality is poor, feature engineering can improve model performance, ensemble methods used can improve predictive performance and robustness, addressing class imbalance in the data, especially for classification tasks, regularization can help prevent overfitting by adding penalty terms to the model's loss function, mitigating biases and ensure fairness in the decision-making process, columns filter operation are processed better in upstream than downstream, and accuracy is not always the best metric, should use appropriate evaluation metrics depending on the problem type.

In exemplary embodiments, defining the best practices of creating a machine learning pipeline includes extracting the best practice information from the existing machine learning pipeline data that has been collected by a machine learning experiment system deployed within an organization. For example, an administrator of the machine learning experiment system may analyze data of the previously performed machine learning experiments and the associated machine learning pipelines to define the best practices for creating a machine learning pipeline.

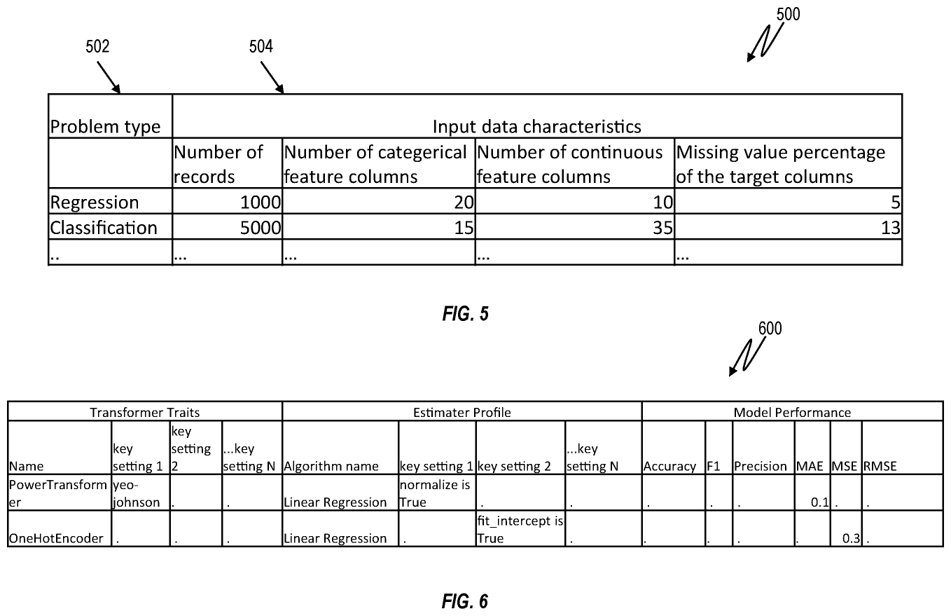

In exemplary embodiments, the analysis of the previously performed machine learning experiments and the associated machine learning pipelines includes collecting statistics for the input data set associated with each machine learning experiment. For example, the number of records, the number of categorical/continuous feature columns, the missing value percentage of the target/feature columns, the number of unbalanced target columns, and the like. The analysis of the previously performed machine learning experiments and the associated machine learning pipelines may also include grouping the machine learning pipelines by doing clustering with an associated problem type and input data set characteristics. For example, using a table 500 such as the one shown in FIG. 5. As shown in FIG. 5, table 500 includes problem types 502 associated with machine learning pipelines and characteristics of the input data set 504 for each machine learning pipeline.

The analysis of the previously performed machine learning experiments and the associated machine learning pipelines also includes defining and generating features for each group of problem type. For example, using a table 600 such as the one shown in FIG. 6, which includes an identification of each machine learning module utilized in a machine learning pipeline, the settings of each machine learning module, and performance statistics for the machine learning pipeline. The analysis of the previously performed machine learning experiments and the associated machine learning pipelines may also include using the data shown in FIG. 6 to cluster the machine learning pipelines based on the metrics used. For the cluster with the best model performance, the frequency for the setting specifications of the transformer and estimator are calculated.

At block 306, the method 300 includes defining scoring rules to measure compliance with the defined best practices. Once the set of best practices has been defined by the administrator of the machine learning experiment system, the administrator generates a set of scoring rules that are used to score the compliance of each machine learning pipeline with the set of best practices. In one example, the set of rules includes a plurality of rules that are each individually used to score the compliance of each machine learning pipeline with an identified best practice. For example, one rule may provide, based on a determination that an original missing value ratio range is in [0, 0.25] and missing values are handled, generate a score value of 1. Another rule may provide, based on a determination that the ratio of the number of final features to the number of original data columns is larger than 1.2, generate a score value of 2. Another rule may provide, based on a determination that any ensemble method is use, generate a score value of 2. Another rule may provide, based on a determination that the problem type is classification, the original Gini coefficient is in [0.05, 0.2], and the imbalance situation is addressed, generate a score value of 3.

Next, as shown at block 308, the method 300 includes obtaining all information required by the set of scoring rules. This information can include, but is not limited to, the problem type (i.e., classification, regression, time series forecasting), the model performance (i.e., accuracy, elapsed time, etc.), setting specifications (e.g., whether an ensemble method is used, what metrics are used, etc.), and a measurement of data being transformed. In one embodiment, to measure how data is transformed data statistics are identified and collected from the input data set and the features of the machine learning pipeline.

At block 310, the method 300 includes scoring the machine learning pipelines. For each pipeline in the group, check all rules to see if any rules are used, and calculate the total score (Ps), which is defined as:

Ps=Σₖ₌₀ⁿS^{k}
where n is the number of the rules and S is the related rule's score value.

Next, as shown at block 312, the method 300 includes providing a machine learning pipeline suggestion for a new machine learning experiment based on an input data set for the new machine learning experiment, a problem to be solved by the machine learning experiment, and the scores associated with the stored machine learning pipelines.

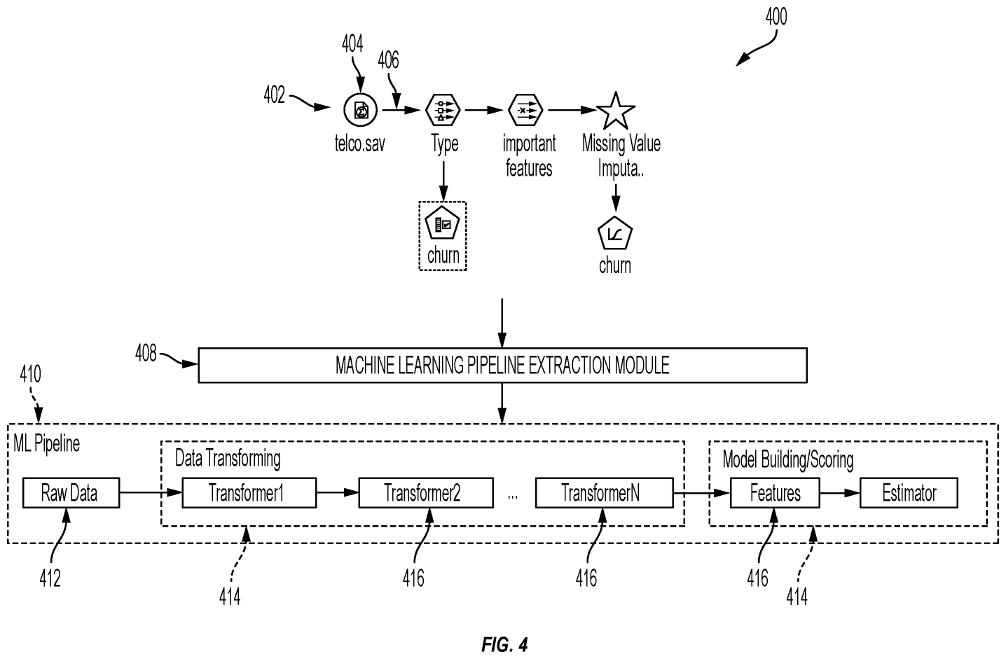

Referring now to FIG. 4, a schematic diagram illustrating a method 400 for creating a machine learning pipeline 410 based on a machine learning experiment 402 in accordance with one or more embodiments of the present invention is shown. In exemplary embodiments, the method 400 is performed by a machine learning experiment system 200 such as the one shown in FIG. 2. In exemplary embodiments, the machine learning experiment system is configured to obtain a definition of a machine learning experiment 402. The definition of a machine learning experiment 402 may be a textual representation of a machine learning experiment or a graphical representation of a machine learning experiment. The definition of a machine learning experiment 402 includes elements 404 which represent machine learning modules utilized in the machine learning experiment and edges 406 which represent the flow of data between the machine learning modules utilized in the machine learning experiment. The definition of a machine learning experiment 402 is provided to the machine learning pipeline extraction module 408, which is configured to responsively create a machine learning pipeline 410. The machine learning pipeline 410 includes the input data set 412, and one or more stages 414. In exemplary embodiments, each of the stages 414 includes one or more machine learning modules that are utilized to execute stage 414 of the machine learning pipeline 410.

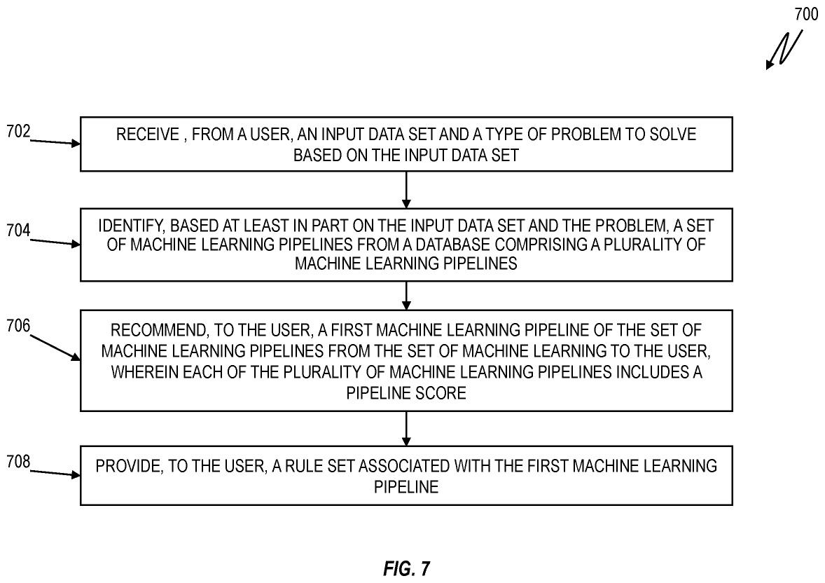

Referring now to FIG. 7, a flow diagram illustrating a computer-implemented method 700 for providing guidance on the use of machine learning tools in accordance with one or more embodiments of the present invention is shown. In exemplary embodiments, the method 700 is performed by a machine learning experiment system 200 such as the one shown in FIG. 2.

At block 702, the method 700 begins by receiving, from a user, an input data set and a type of problem to solve based on the input data set. Next, as shown at block 704, the method 700 includes identifying, based at least in part on the input data set and the problem, a set of machine learning pipelines from a database comprising a plurality of machine learning pipelines. In exemplary embodiments, each of the plurality of machine learning pipelines is created based on an analysis of previously executed machine learning experiments and wherein each of the previously executed machine learning experiments is associated with a previous type of problem and a previous input data set. In exemplary embodiments, the set of machine learning pipelines is identified based on the previous type of problem being the same as the type of problem and a similarity between the previous data set and the input data set exceeding a threshold value. In one embodiment, the similarity between the previous data set and the input data set is calculated by comparing one or more characteristics of the data sets, such as the size of the data sets, the range of values of the data sets, and the like.

Next, as shown at block 706, the method 700 includes recommending, to the user, a first machine learning pipeline of the set of machine learning pipelines from the set of machine learning to the user. In exemplary embodiments, each of the plurality of machine learning pipelines includes a pipeline score and the first machine learning pipeline has the highest pipeline score of the set of machine learning pipelines.

In exemplary embodiments, each of the plurality of machine learning pipelines includes a sequence of stages that include one or more of data ingestion, data validation, feature extraction, machine learning model/version selection, training data selection/preparation, model training, model evaluation, and model validation. Each of the plurality of machine learning pipelines includes a machine learning module associated with each of the sequence of stages.

In exemplary embodiments, each of the previously executed machine learning experiments includes a sequence of stages, a machine learning module associated with each of the sequence of stages, and one or more metrics associated with the previously executed machine learning experiments. The pipeline score of each of the plurality of machine learning pipelines is created by applying a set of scoring rules to one or more metrics associated with the previously executed machine learning experiments. In exemplary embodiments, one or more metrics associated with the previously executed machine learning experiments, include performance metrics for the machine learning modules associated with each of the sequences of stages. The method 700 concludes at block 708 by providing, to the user, a rule set associated with the first machine-learning pipeline. In exemplary embodiments, the rule set includes one or more suggested settings associated with the first machine-learning pipeline.

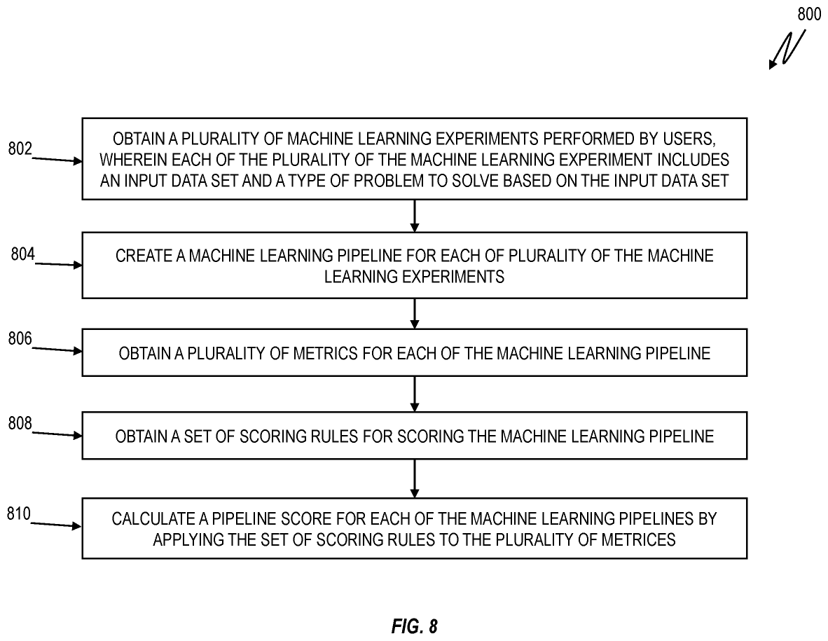

Referring now to FIG. 8, a flow diagram illustrating a computer-implemented method 800 for creating a database of machine learning pipelines for guidance on the use of machine learning tools in accordance with one or more embodiments of the present invention is shown. In exemplary embodiments, the method 800 is performed by a machine learning experiment system 200 such as the one shown in FIG. 2.

At block 802, the method 800 begins by obtaining a plurality of machine learning experiments performed by users, wherein each of the plurality of the machine learning experiments includes an input data set and a type of problem to solve based on the input data set. Next, as shown at block 804, the method 800 includes creating a machine learning pipeline for each of plurality of the machine learning experiments, the machine learning pipeline includes a sequence of stages including one or more of data ingestion, data validation, feature extraction, machine learning model/version selection, training data selection/preparation, model training, model evaluation, and model validation performed during the machine learning experiments.

At block 806, the method 800 includes obtaining a plurality of metrics for each of the machine learning pipelines. In exemplary embodiments, obtaining a plurality of metrics for each of the machine learning pipelines includes performing a statistical analysis on the input data set. In exemplary embodiments, obtaining a plurality of metrics for each of the machine learning pipelines includes grouping the plurality of machine learning experiments based on the type of problem and generating features and performance metrics for each group. In one embodiment, obtaining a plurality of metrics for each of the machine learning pipelines further includes clustering each of the groups based on the generated features, and identifying a cluster having the highest average performance metric. Next, as shown at block 808, the method 800 includes obtaining a set of scoring rules for scoring the machine learning pipeline, wherein the set of scoring rules are based on the plurality of metrics, characteristics of the input data set, and the type of the problem. The method 800 ends at block 810 by calculating a pipeline score for each of the machine learning pipelines by applying the set of scoring rules to the plurality of metrics, characteristics of the input data set, and the type of the problem.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for providing guidance on use of machine learning tools, the computer-implemented method comprising:
receiving, from a user, an input data set and a type of problem to solve based on the input data set;
identifying, based at least in part on the input data set and the problem, a set of machine learning pipelines from a database comprising a plurality of machine learning pipelines;
recommending, to the user, a first machine learning pipeline of the set of machine learning pipelines from the set of machine learning to the user, wherein each of the plurality of machine learning pipelines includes a pipeline score and wherein the first machine learning pipeline has a highest pipeline score of the set of machine learning pipelines; and
providing, to the user, a rule set associated with the first machine learning pipeline, wherein the rule set includes one or more suggested settings associated with the first machine learning pipeline.

2. The computer-implemented method of claim 1, wherein each of the plurality of machine learning pipelines includes a sequence of stages that include one or more of data ingestion, data validation, feature extraction, machine learning model/version selection, training data selection/preparation, model training, model evaluation, and model validation.

3. The computer-implemented method of claim 2, wherein each of the plurality of machine learning pipelines includes a machine learning module associated with each of the sequence of stages.

4. The computer-implemented method of claim 1, wherein each of the plurality of machine learning pipelines are created based on an analysis of previously executed machine learning experiments and wherein each of the previously executed machine learning experiments is associated with a previous type of problem and a previous input data set.

5. The computer-implemented method of claim 4, wherein the set of machine learning pipelines is identified based on the previous type of problem being the same as the type of problem and a similarity between the previous input data set and the input data set exceeding a threshold value.

6. The computer-implemented method of claim 4, wherein each of the previously executed machine learning experiments includes a sequence of stages, a machine learning module associated with each of the sequence of stages, and one or more metrics associated with the previously executed machine learning experiments.

7. The computer-implemented method of claim 6, wherein the pipeline score of each of the plurality of machine learning pipelines is created by applying a set of scoring rules to the one or more metrics associated with the previously executed machine learning experiments.

8. The computer-implemented method of claim 6, wherein the one or more metrics associated with the previously executed machine learning experiments, include performance metrics for the machine learning modules associated with each of the sequence of stages.

9. A computing system for providing guidance on use of machine learning tools, the computing system comprising a processor configure to:
receive, from a user, an input data set and a type of problem to solve based on the input data set;
identify, based at least in part on the input data set and the problem, a set of machine learning pipelines from a database comprising a plurality of machine learning pipelines;
recommend, to the user, a first machine learning pipeline of the set of machine learning pipelines from the set of machine learning to the user, wherein each of the plurality of machine learning pipelines includes a pipeline score and wherein the first machine learning pipeline has a highest pipeline score of the set of machine learning pipelines; and
provide, to the user, a rule set associated with the first machine learning pipeline, wherein the rule set includes one or more suggested settings associated with the first machine learning pipeline.

10. The computing system of claim 9, wherein each of the plurality of machine learning pipelines includes a sequence of stages that include one or more of data ingestion, data validation, feature extraction, machine learning model/version selection, training data selection/preparation, model training, model evaluation, and model validation.

11. The computing system of claim 10, wherein each of the plurality of machine learning pipelines includes a machine learning module associated with each of the sequence of stages.

12. The computing system of claim 9, wherein each of the plurality of machine learning pipelines are created based on an analysis of previously executed machine learning experiments and wherein each of the previously executed machine learning experiments is associated with a previous type of problem and a previous input data set.

13. The computing system of claim 12, wherein the set of machine learning pipelines is identified based on the previous type of problem being the same as the type of problem and a similarity between the previous input data set and the input data set exceeding a threshold value.

14. The computing system of claim 13, wherein each of the previously executed machine learning experiments includes a sequence of stages, a machine learning module associated with each of the sequence of stages, and one or more metrics associated with the previously executed machine learning experiments.

15. The computing system of claim 14, wherein the pipeline score of each of the plurality of machine learning pipelines is created by applying a set of scoring rules to the one or more metrics associated with the previously executed machine learning experiments.

16. The computing system of claim 15, wherein the one or more metrics associated with the previously executed machine learning experiments, include performance metrics for the machine learning modules associated with each of the sequence of stages.

17. A computer-implemented method for creating a database of machine learning pipelines for guidance on use of machine learning tools, the computer-implemented method comprising:
obtaining a plurality of machine learning experiments performed by users, wherein each of the plurality of the machine learning experiment includes an input data set and a type of problem to solve based on the input data set;
creating a machine learning pipeline for each of plurality of the machine learning experiments, the machine learning pipeline including a sequence of stages including one or more of data ingestion, data validation, feature extraction, machine learning model/version selection, training data selection/preparation, model training, model evaluation, and model validation performed during the machine learning experiments;
obtaining a plurality of metrics for each of the machine learning pipelines;
obtaining a set of scoring rules for scoring the machine learning pipeline, wherein the set of scoring rules are based on the plurality of metrics, characteristics of the input data set, the type of the problem; and
calculate a pipeline score for each of the machine learning pipelines by applying the set of scoring rules to the plurality of metrics, characteristics of the input data set, the type of the problem.

18. The computer-implemented method of claim 17, wherein obtaining a plurality of metrics for each of the machine learning pipelines includes performing a statistical analysis on the input data set.

19. The computer-implemented method of claim 17, wherein obtaining a plurality of metrics for each of the machine learning pipelines includes grouping the plurality of machine learning experiments based on the type of problem and generating features and performance metrics for each group.

20. The computer-implemented method of claim 19, wherein obtaining a plurality of metrics for each of the machine learning pipelines further includes clustering each of the groups based on the generated features, identifying a cluster having a highest average performance metric.
